(19) United States
(12) Patent Application Publication
(10) Pub. No.: US 2025/0020165 A1
(43) Pub. Date: Jan. 16, 2025

(54) SINTERED BUSHINGS AND METHODS FOR MAKING THE SAME

(71) Applicant: Garrett Transportation I Inc., Torrance, CA (US)

(72) Inventors: Petr Balon, Pozorice (CZ); Philippe Renaud, Sanchey (FR); Marek Slouka, Brno (CZ)

(73) Assignee: Garrett Transportation I Inc., Torrance, CA (US)

(21) Appl. No.: 18/351,185

(22) Filed: Jul. 12, 2023

(51) Int. Cl. F16C 33/12; F16C 33/14

(52) U.S. Cl. CPC F16C 33/128; F16C 33/145; F16C 2204/52; F16C 2204/72

(57) ABSTRACT

A bushing includes a first wall section disposed about a channel. The first wall section is formed of a first sintered powdered metal alloy having a first mean sintering temperature in powdered form. A second wall section is disposed adjacent and affixed to the first wall section about the channel. The second wall section is formed of a second sintered powdered metal alloy having a second mean sintering temperature in powdered form that is different than the first mean sintering temperature. The difference between the first and second mean sintering temperatures is about 150° C. or less.

### TECHNICAL FIELD

The present disclosure generally relates to bushings for turbochargers or the like. More particularly, the present disclosure relates to multi-layered sintered bushings for turbochargers or the like and methods for making such bushings.

### BACKGROUND

Bushings for high temperature applications, such as, for example, turbochargers or the like, often see a wide range of temperatures and environments. Such bushings typically require specific geometries, very precise dimensions, and excellent wear resistance, corrosion, and oxidation resistance at elevated temperatures. For example, bushings used in wastegate turbochargers may be made from a specific material determined for specific operating conditions and temperature ranges. Further, such bushings may experience a very high temperature in one region of the bushing while being subjected to a considerably lower temperature in other regions. The same applies to wear, in which some regions are exposed to higher wear environments while other regions are exposed to relatively less wear.

Sometimes, a bushing is designed as a compromise. A number of factors are taken into account and the appropriate material is selected to produce the bushing. These factors may include thermal and mechanical properties, oxidation and corrosion resistance, and wear resistance, over a wide range of temperatures. This may result in a portion of the bushing being subjected to operating conditions for which the alloy composition is under-designed. Or, more commonly, the entire bushing has to be overdesigned to ensure adequate performance in all the different operating conditions experienced over its length. In the latter case, the entire bushing may be made from a high-grade material that represents a very expensive solution and increases the price of the turbocharger itself.

Accordingly, it is desirable to provide bushings for turbochargers or other relatively high temperature and/or high wear applications that address one or more of the foregoing issues and methods for making such bushings. Furthermore, other desirable features and characteristics of the present disclosure will become apparent from the subsequent detailed description and the appended claims, taken in conjunction with the accompanying drawings and this background.

### BRIEF SUMMARY

Bushings formed of sintered powdered metal alloys and methods for making such bushings are provided.

In an embodiment, by way of example only, a bushing includes a first wall section disposed about a channel. The first wall section is formed of a first sintered powdered metal alloy having a first mean sintering temperature in powdered form. A second wall section is disposed adjacent and affixed to the first wall section about the channel. The second wall section is formed of a second sintered powdered metal alloy having a second mean sintering temperature in powdered form that is different than the first mean sintering temperature. A difference between the first and second mean sintering temperatures is about 150° C. or less.

In another embodiment, by way of example only, a bushing includes an interior wall section disposed about a channel. The interior wall section is formed of a sintered powdered cobalt-based alloy or a nickel-based alloy or a stainless steel alloy having a first mean sintering temperature in powdered form of from about 950° C. to about 1250° C. An exterior wall section is disposed about and affixed to the interior wall section. The exterior wall section is formed of a sintered powdered stainless steel alloy having a second mean sintering temperature in powdered form of from about 1050° C. to about 1350° C.

In another embodiment, by way of example only, a method for making a bushing includes providing or obtaining a first powdered metal alloy and a second powdered metal alloy that is different than the first powdered metal alloy. The first powdered metal alloy has a first mean sintering temperature, and the second powdered metal alloy has a second mean sintering temperature that is different than the first mean sintering temperature. A difference between the first and second mean sintering temperatures is about 150° C. or less. A first binder is mixed with the first powdered metal alloy to form a first mixture. A second binder is mixed with the second powdered metal alloy to form a second mixture. A bi-metal injection molding process is performed to form a green component in a shape of the bushing. The green component includes a first green wall section disposed about a channel and formed of the first mixture. The green component further includes a second green wall section disposed adjacent to the first green wall section about the channel and formed of the second mixture. The green component is debind to form a brown component in the shape of the bushing having a porous structure. The brown component is sintered at a sintering temperature effective to densify and sinter the brown component including the first and second powdered metal alloys to form the bushing.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The inventive subject matter will hereinafter be described in conjunction with the following drawing figures, wherein like numerals denote like elements, and wherein:

FIG. 1 illustrates a cross-sectional view of a bushing according to one or more embodiments of the disclosure.

FIG. 2 is a flowchart of a method for making a bushing according to one or more embodiments of the disclosure.

FIG. 3 illustrates a cross-sectional view of a bushing during an intermediate fabrication stage according to one or more embodiments of the disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The present disclosure is generally directed to multi-layered sintered bushings for turbochargers or the like and methods for making such bushings. In accordance with one or more embodiments of the disclosure, a bushing includes a first wall section disposed about a channel. The first wall section is formed of a first sintered powdered metal alloy having a first mean sintering temperature when in powdered form. A second wall section is disposed adjacent and affixed to the first wall section about the channel. The second wall section is formed of a second sintered powdered metal alloy having a second mean sintering temperature when in powdered form that is different than the first mean sintering temperature. The difference between the first and second mean sintering temperatures is about 150° C. or less.

In one or more embodiments of the disclosure, the first sintered powdered metal alloy is formed of a relatively high wear resistant, sintered powdered cobalt-based alloy, and the second sintered powdered metal alloy is formed of a relatively economical-lower wear resistant, sintered powdered stainless steel alloy. As such, for relatively high temperature applications in which the first wall section is exposed to higher wear environments, for example as a bearing surface that interfaces with a moving part(s), e.g., shaft or the like, while the second wall section is exposed to lower or no wear environments, the entire bushing can be efficiently and economically designed to ensure adequate performance over its length. Further, by forming the first and second wall sections from different powdered metal alloys with a difference between the first and second mean sintering temperatures of about 150° C. or less, the bushing can be formed by sintering the different powder metal alloys together at a single or common sintering temperature that ensures that both the first and second powdered metal alloys are sintered individually and to each other to form a more densified, multi-layered sintered bushing in which the first and second wall sections are affixed to each other to enhance the structural integrity of the bushing.

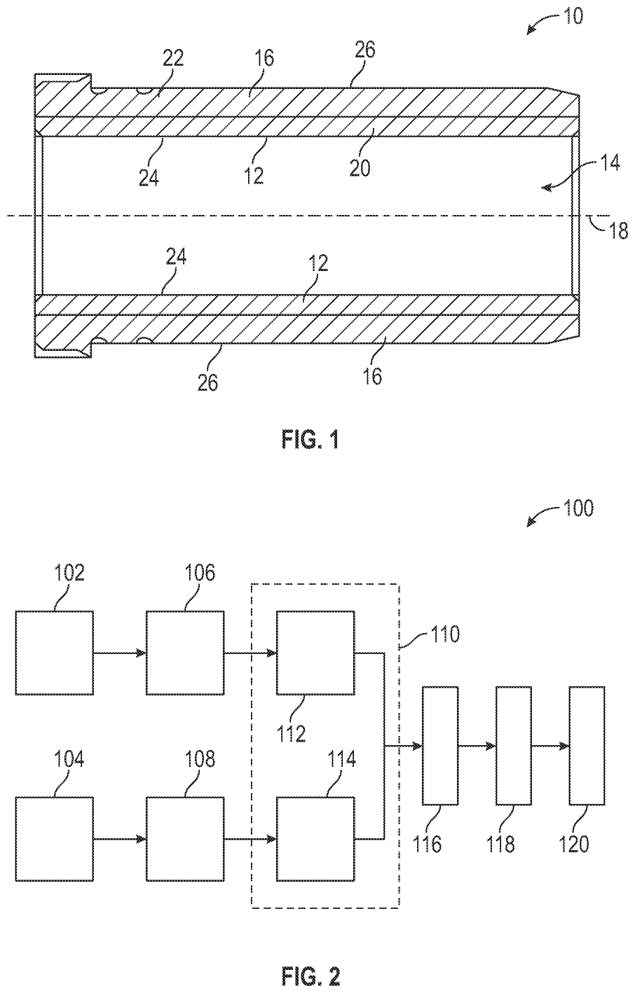

FIG. 1 is a cross-sectional view of a bushing 10 according to one or more embodiments of the disclosure. The bushing 10 includes an interior wall section 12 disposed about a channel 14, e.g., bore opening. An exterior wall section 16 is disposed about and affixed to the interior wall section 12. As illustrated, the bushing 10 is a substantially straight bushing with the channel 14 and wall sections 12 and 16 extending longitudinally about and substantially parallel to an axis 18.

The interior wall section 12 is formed of a sintered powdered metal alloy 20. The exterior wall section 16 is formed of a sintered powdered metal alloy 22 that is different than the sintered powdered metal alloy 20. In one embodiment, the sintered powdered metal alloy 20 includes or is formed of a relatively high wear resistant, sintered powdered metal alloy, for example a sintered powdered cobalt-based alloy or a nickel-based alloy or a stainless steel alloy while the sintered powdered metal alloy 22 includes or is formed of a relatively economical-lower wear resistant, sintered powdered metal alloy, for example a sintered powdered stainless steel alloy (or alternatively a sintered powdered cobalt-based alloy or a sintered powdered nickel-based alloy).

In this configuration, for example, the inner surface 24 of the interior wall section 12 may be exposed to a higher wear environment(s), for example as a bearing surface that interfaces with a moving part(s), e.g., shaft or the like, while the outer surface 26 of the exterior wall section 16 may be exposed to a lower or no wear environment(s). Alternatively, the sintered powdered metal alloy 20 includes or is formed of a relatively economical-lower wear resistant, sintered powdered metal alloy while the sintered powdered metal alloy 22 includes or is formed of a relatively high wear resistant, sintered powdered metal alloy for applications in which the outer surface 26 is exposed to a higher wear environment(s) and the inner surface 24 is exposed to a lower or no wear environment(s). Advantageously, in one or more embodiments, the entire bushing 10 can be efficiently and economically designed to ensure adequate performance over its length for applications with localized different operating and/or wear conditions.

In one embodiment, the sintered powdered metal alloy 20 includes or is formed of a cobalt-based alloy, such as, for example, a cobalt-based type T-400 alloy (See Table 1). In another embodiment, the sintered powdered metal alloy 22 includes or is formed of a stainless steel alloy, such as, for example, a stainless steel type 441 alloy (See Table 2) or a stainless steel type 430 alloy (See Table 3).

TABLE 1
T-400

| Element | Min (%) | Max (%) |
|---|---|---|
| Si | 1.8 | 3.0 |
| Cr | 7 | 9 |
| Mo | 25 | 30 |
| C | 0.00 | 0.08 |
| P | 0.0 | 0.04 |
| S | 0.0 | 0.04 |
| Ni | 0.0 | 1.5 |
| Fe | 0.0 | 1.5 |
| Others (Total) | 0.0 | 1.0 |

| | |
|---|---|
| Co | Balance |

TABLE 2
SS 441

| Element | Min (%) | Max (%) |
|---|---|---|
| C | — | 0.03 |
| Si | — | 1.0 |
| Mn | — | 1.0 |
| Cr | 17.0 | 18.5 |
| Nb | (9 × C + 0.3) | 1.0 |
| Ti | 0.1 | 0.6 |
| S | — | 0.015 |
| P | — | 0.04 |
| Other (Total) | — | 1.0 |

| | |
|---|---|
| Fe | Balance |

TABLE 3
SS 430

| Element | Min (%) | Max (%) |
|---|---|---|
| C | — | 0.12 |
| Mn | — | 1.0 |
| P | — | 0.04 |
| S | — | 0.03 |
| Si | — | 1.0 |
| Cr | 14 | 18.0 |

| | |
|---|---|
| Fe | Balance |

FIG. 2 is a flowchart of a method 100 for making the bushing 10 according to one or more embodiments of the disclosure. Referring to FIGS. 1-2, the method 100 includes providing or obtaining (STEP 102) a first powdered metal alloy. In one embodiment, the first powdered metal alloy is the sintered powdered metal alloy 20 in powdered form (prior to or before sintering) and has a first mean sintering temperature. In one example, the first powdered metal alloy is a powdered cobalt-based alloy or a nickel-based alloy or a stainless steel alloy having a first mean sintering temperature of from about 950° C. to about 1250° C.

The method 100 further includes providing or obtaining (STEP 104) a second powdered metal alloy that is different than the first powdered metal alloy. In one embodiment, the second powdered metal alloy is the sintered powdered metal alloy 22 in powdered form (prior to or before sintering) and has a second mean sintering temperature. In one example, the second powdered metal alloy is a powdered stainless steel alloy (or alternatively a powdered cobalt-based alloy or a nickel-based alloy) having a second mean sintering temperature in powdered form of from about 1050° C. to about 1350° C. In one or more embodiments of the disclosure, a difference between the first and second mean sintering temperatures is about 150° C. or less, for example from about 1° C. to about 150° C., such as about 120° C. or less, for example from about 1° C. to about 120° C., such as 110° C. or less, for example from about 1° C. to about 110° C., such as 100° C. or less, for example from about 1° C. to about 100° C., such as about 5° C. to about 100° C., such as about 10° C. to about 90° C., or alternatively, for example about 0° C. to about 5° C., such as greater than about 0° C. to about 5° C., for example about 0.05° C. to about 5° C.

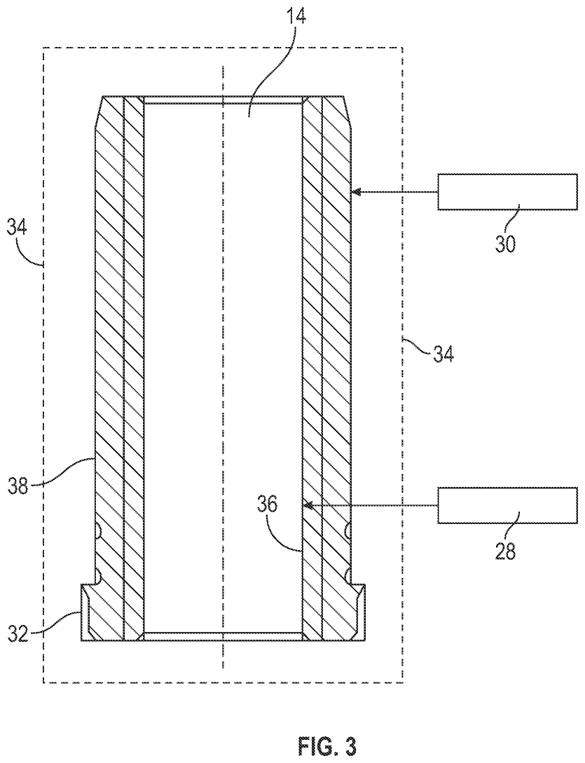

FIG. 3 is a cross-sectional view of the bushing 10 during an intermediate fabrication stage according to one or more embodiments of the disclosure. Referring to FIGS. 1-3, feedstocks 28 and 30 are formed for subsequent injection molding. In particular, a first binder is mixed (STEP 106) with the first powdered metal alloy to form a first feedstock or mixture 28. Likewise, a second binder is mixed (STEP 108) with the second powdered metal alloy to form a second feedstock or mixture 30. Examples of binders include, but are not limited to, thermoplastic resins, waxes, and combinations thereof. Non-limiting examples of thermoplastic resins include polyolefins such as acrylic polyethylene, polypropylene, polystyrene, polyvinyl chloride, polyethylene carbonate, polyethylene glycol, and mixtures thereof. Suitable waxes include, but are not limited to, microcrystalline wax, bee wax, synthetic wax, and combinations thereof.

In one or more embodiments of the disclosure, the first and second feedstocks 28 and 30 may be prepared by mixing the corresponding powdered metal alloys with the corresponding binders and heating the blend to form a corresponding slurry. Uniform dispersion of the powdered metal alloy in the slurry may be achieved by employing high shear mixing. Each of the slurries may then be cooled to ambient temperature and then granulated to provide the feedstocks 28 and 30 for metal injection molding.

The amount of powdered metal alloys and binders in the feedstocks 28 and 30 may be selected to optimize moldability while insuring acceptable green densities. In one embodiment, each of the feedstocks 28 and 30, independently, includes at least about 80 percent by weight the corresponding powdered metal alloy. In yet another embodiment, each of the feedstocks 28 and 30, independently, includes at least about 85 percent by weight of the corresponding powdered metal alloys. In yet another embodiment, each of the feedstocks 28 and 30, independently, includes at least about 90 percent by weight of the corresponding powdered metal alloy.

The method 100 continues by performing (STEP 110) a bi-metal injection molding process to form a green component 32 (un-sintered powder metal form held together with binder(s)) in a shape of the bushing 10. A bi-metal injection molding process is herein understood to mean a molding process that enables the combination of two different metal powder feedstocks to be molded into the same part. By injecting feedstocks from different injection units, it becomes possible to combine different materials and produce parts with complementing characteristics. Examples of bi-metal injection molding processes include a metal powder over-molding process, an insert metal injection molding process, and a metal co-injection molding process. In particular, a metal powder over-molding process uses a powder injection molding machine with two injection molding units and a mold with a rotation device. Initially, a green part is produced in a molding cavity in a first working position. Next, the mold is opened, and a second working position is achieved after a molding rotation of 180°. Next, the green part is in the second working position for the injection of the second component. For an insert metal injection molding process, the process initially includes injection of a first mass into a mold to form a pre-injected part. Next, the pre-injected part is inserted into a second mold. Next, a second mass is injected into the second mold with the pre-injected part to form the green part. For a metal co-injection process, the process includes a powder injection molding machine with two injection molding units. Initially, a skin material is injected by a vertical injection unit into a molding cavity. Next, a core material is injected by a horizontal injection unit. Next, a second injection of skin material ends the cycle so that the first component is completely encapsulated in the second component (e.g., skin materials).

In one or more embodiments, feedstocks 28 and 30 are independently injected into different regions of a bushing shaped mold cavity in an injection molding machine 34, using for example one of the foregoing bi-metal injection molding techniques. In one or more embodiments of the disclosure, the bi-metal injection molding is performed at an elevated temperature, for example from about 100° C. to about 200° C., such as about 150° C. The result of the injection molding is a bushing shaped compact referred to as the green component 32.

In one embodiment and as illustrated, the green component 32 is formed by injecting (STEP 112) the feedstock 28 into a first region of the mold to form a first green wall section 36 that is disposed about the channel 14. Likewise, the feedstock 30 is injected (STEP 114) into a second region of the mold to form a second green wall section 38 that is disposed adjacent to and overlies the first green wall section 36 about the channel 14. Once formed, the green component 32 is removed from the injection molding machine 34.

The method 100 continues by debinding (STEP 116) the green component 32 to form a brown component (un-sintered powder metal, porous form with a substantial portion of the binder(s) removed but with enough structure integrity to hold its shape) in the shape of the bushing 10 having a porous structure. In one or more embodiments, debinding is a process of removing the binder(s) and can include solvent debinding individually, or thermal debinding individually, or the combination of solvent debinding and thermal debinding to form the brown component. In one embodiment, the step of debinding the green component 32 includes initially debinding the green component 32 in a solvent debinding process. For solvent debinding, the binder composition should include a composition that is soluble in an organic solvent at low temperatures, such that a network of interconnected porosity is formed in the green component 32 when the green component 32 is placed in the organic solvent. Exemplary organic solvents include acetone, trichloroethylene, and heptane. The green component 32 may then undergo further debinding in a thermal debinding process. For thermal debinding, the green component 32 is placed in an oven. The temperature of the oven may range from about 400° C. to about 600° C., for example from about 450° C. to about 550° C. The temperature may be varied within this range during thermal debinding. Thermal debinding may be performed in the oven for a total time of about 30 minutes to about 4 hours, for example about 45 minutes to about 3 hours. Drying of the component also occurs during this time in the oven. Once the binder(s) is removed through the combination of solvent debinding and thermal debinding, what remains is a somewhat porous bushing shaped component known as a brown component.

The method 100 continues by sintering (STEP 118) the brown component at a sintering temperature effective to densify and sinter the brown component including the first and second powdered metal alloys to form the bushing 10. In particular, sintering is the process of compacting and forming a solid mass of material by heat and/or pressure without melting it to the point of liquefaction. In some embodiments, sintering includes heating the brown component at a temperature of from about 1100° C. to about 1400° C., for example from about 1250° C. to about 1300° C., depending of course on the choice of powdered metal(s). Sintering may be performed for a time period including, but not limited to, a duration of from about 0.5 hours to about 12 hours, for example about 2 hours to about 8 hours, such as about 4 hours to about 8 hours. A fully densified, bushing 10 results from the sintering process.

Subsequent to sintering, one or more finishing steps (STEP 120) may be performed, such as surface smoothing, machining to achieve final tolerances, and the like. The present disclosure should be understood to be inclusive of all conventional post fabrication machining. as known in the art. Thereafter, the bushings 10, fabricated in the foregoing manner, may be assembled, along with other necessary components, into a turbocharger or the like.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A bushing comprising:
a first wall section disposed about a channel, wherein the first wall section is formed of a first sintered powdered metal alloy having a first mean sintering temperature in powdered form; and
a second wall section disposed adjacent and affixed to the first wall section about the channel, wherein the second wall section is formed of a second sintered powdered metal alloy having a second mean sintering temperature in powdered form that is different than the first mean sintering temperature, wherein a difference between the first and second mean sintering temperatures is about 150° C. or less.

2. The bushing of claim 1, wherein the difference between the first and second mean sintering temperatures is about 100° C. or less.

3. The bushing of claim 1, wherein the difference between the first and second mean sintering temperatures is from about 1° C. to about 100° C.

4. The bushing of claim 1, wherein the difference between the first and second mean sintering temperatures is greater than about 0° C. to about 5° C.

5. The bushing of claim 1, wherein the first mean sintering temperature is from about 950° C. to about 1250° C.

6. The bushing of claim 1, wherein the second mean sintering temperature is from about 1050° C. to about 1350° C.

7. The bushing of claim 1, wherein the first sintered powdered metal alloy comprises a cobalt-based alloy, a nickel-based alloy, or a stainless steel alloy.

8. The bushing of claim 1, wherein the second sintered powdered metal alloy comprises a stainless steel alloy, a cobalt-based alloy, or a nickel-based alloy.

9. The bushing of claim 1, wherein the first wall section is an interior wall section and the second wall section is an exterior wall section that is disposed about and affixed to the interior wall section.

10. A bushing comprising:
an interior wall section disposed about a channel, wherein the interior wall section is formed of a sintered powdered cobalt-based alloy having a first mean sintering temperature in powdered form of from about 950° C. to about 1250° C.; and
an exterior wall section disposed about and affixed to the interior wall section, wherein the exterior wall section is formed of a sintered powdered stainless steel alloy having a second mean sintering temperature in powdered form of from about 1050° C. to about 1350° C.

11. A method for making a bushing, the method comprising:
providing or obtaining a first powdered metal alloy and a second powdered metal alloy that is different than the first powdered metal alloy, wherein the first powdered metal alloy has a first mean sintering temperature and the second powdered metal alloy has a second mean sintering temperature that is different than the first mean sintering temperature, wherein a difference between the first and second mean sintering temperatures is about 150° C. or less;
mixing a first binder with the first powdered metal alloy to form a first mixture;
mixing a second binder with the second powdered metal alloy to form a second mixture;
performing a bi-metal injection molding process to form a green component in a shape of the bushing, wherein the green component comprises:
a first green wall section disposed about a channel and formed of the first mixture; and
a second green wall section disposed adjacent to the first green wall section about the channel and formed of the second mixture;
debinding the green component to form a brown component in the shape of the bushing having a porous structure; and
sintering the brown component at a sintering temperature effective to densify and sinter the brown component including the first and second powdered metal alloys to form the bushing.

12. The method of claim 11, wherein performing a bi-metal injection molding process comprises performing a bi-metal injection molding process that is chosen from a metal powder over-molding process, an insert metal injection molding process, or a metal co-injection molding process.

13. The method of claim 11, wherein the difference between the first and second mean sintering temperatures is about 100° C. or less.

14. The method of claim 11, wherein the first mean sintering temperature is from about 950° C. to about 1250° C.

15. The method of claim 11, wherein the second mean sintering temperature is from about 1050° C. to about 1350° C.

16. The method of claim 11, wherein sintering comprises sintering the brown component at the sintering temperature of from about 1100° C. to about 1400° C. for a time period of about 0.5 hours to about 12 hours.

17. The method of claim 11, wherein the first and second binders are independently chosen from a thermoplastic resin(s), a wax(es), or combinations thereof.

18. The method of claim 11, wherein debinding comprises solvent debinding.

19. The method of claim 11, wherein debinding comprises thermal debinding.

20. The method of claim 11, further comprising performing a finishing process on the bushing.
